(19) United States
(12) Patent Application Publication
(10) Pub. No.: US 2010/0287621 A1
(43) Pub. Date: Nov. 11, 2010

(54) Method For The Use-Specific Initialization Of Vehicle Devices

(75) Inventor: Oliver Nagy, Wien (AT)

Correspondence Address: HOFFMANN & BARON, LLP, 6900 JERICHO TURNPIKE, SYOSSET, NY, 11791, US

(73) Assignee: KAPSCH TRAFFICCOM AG, Wien (AT)

(21) Appl. No.: 12/773,089

(22) Filed: May 4, 2010

(30) Foreign Application Priority Data
May 5, 2009 (EP) 09 450 094.9

(51) Int. Cl. G06F 21/00; G06Q 50/00

(52) U.S. Cl. 726/28; 705/16

(57) ABSTRACT

Method for the use-specific initialization of vehicle devices of a road toll system, wherein the devices communicate with a central system via a radio interface and have device identifiers (OID), the method including the steps of: registering driver data under a driver identifier (AID) and vehicle data under a vehicle identifier (VID) in the central system; allocating a use identifier (UID) to a driver identifier (AID) and to a vehicle identifier (VID) in the central system; input of the use identifier (UID) into a vehicle device; transmitting the use identifier (UID) and the device identifier (OID) from the vehicle device to the central system via the radio interface; registering the driver data and vehicle data for each driver identifier (AID) and vehicle identifier (VID) to which the received use identifier (UID) is allocated in the central system; transmitting the determined driver data and vehicle data from the central system back to the vehicle device specified by the received device identifier (OID) via the radio interface; and initializing the vehicle device with the received driver data and vehicle data.

### FIELD OF THE INVENTION

The present invention relates to a method for the use-specific initialization of vehicle devices of a road toll system, wherein these devices communicate with a central system and have device identifiers.

### BACKGROUND OF THE INVENTION

Vehicle devices of this type, so-called “onboard units” or OBUs, are typically manufactured without allocation to a specific user or field of use and are initialized with specific data only at delivery and transfer to the user (“personalization”). The initialization is here performed directly at the point of delivery or sale of the OBU, at the so-called “Point of Sale” (POS) by means of special reading and writing devices via a short-range radio interface (dedicated short-range communication, DSRC).

This has the disadvantage that the initialization of an OBU is limited to the location of the points of sale, which makes the initialization of OBUs permanently installed in new vehicles, e.g., integrated in a car radio, more difficult. Also, changing the initialization of an already delivered OBU requires it to be brought back to a point of sale each time. This is problematic for short-term, temporary, and/or frequent changes in the initialization, as would be extremely desirable, e.g., when changing drivers for a rental car, when changing cars for people who own two cars, or when using an OBU for different vehicles in a fleet.

### SUMMARY OF THE INVENTION

The invention sets for itself the goal of eliminating the disadvantages of the prior art and of creating a method for the simple and quick first initialization and new initialization of an OBU.

This goal is achieved with a method of the type named above that distinguishes itself through the steps of: registering driver data under a driver identifier and vehicle data under a vehicle identifier in the central system; allocating a use identifier to a driver identifier and to a vehicle identifier in the central system; inputting of the use identifier to a vehicle device;

transmitting the use identifier and the device identifier from the vehicle device to the central system via the radio interface; determining the driver data and vehicle data for each driver identifier and vehicle identifier to which the received use identifier is allocated in the central system; transmitting the determined driver data and vehicle data from the central system back to the vehicle device specified by the received device identifier via the radio interface; and initializing the vehicle device with the received driver data and vehicle data.

The invention allows, for the first time, a quick and simple initialization of an OBU during the operation of a vehicle, in some sense, “on the trip.” Thus, e.g., a personalization of factory-new vehicles with preinstalled OBUs is possible or a quick change is possible at any time to individual initialization data, such as data on the vehicle for which the OBU is currently being used, data on the driver currently operating the vehicle, data on the billing account when it involves, e.g., a “post-pay” OBU, data on the toll operator responsible for the OBU, etc. The invention relates, in particular, to the use of separate, use-specific identifiers that combine an identifier for the user or driver with an identifier for the object of use or vehicle.

The use identifier can be issued by the user himself or by the central system and output to the user. In both cases, the use identifier can be both freely selected and also based on the driver identifier and/or the vehicle identifier; in the simplest case, they may be equal, e.g., to the driver identifier or vehicle identifier. Preferably, however, the use identifier involves an identifier that combines the driver identifier and the vehicle identifier and that thus designates the specific use of an OBU with respect to a certain driver and a certain vehicle.

The latter opens up the possibility that the input of the use identifier to the vehicle device takes place by connecting a first memory card with the driver identifier and a second memory card with the vehicle identifier to the vehicle device, for which the user may use, e.g., an electronic driver's license memory chip and an electronic registration label or also a vehicle key memory chip. Alternatively, the input of the use identifier to the vehicle device can take place by connecting at least a single memory card with the use identifier stored on this card, so that the user requires, e.g., only one single chip. In principle, however, it is also possible that the input is performed simply by the user by means of an input device of the vehicle device, e.g., by means of a keypad.

In all of these cases, it is also especially favorable when the input device or memory card(s) are connected wirelessly to the vehicle device, preferably via an infrared, Bluetooth, or RFID interface. For this purpose, the user may employ, for example, the keypad of a car radio communicating wirelessly with the OBU or may control its memory cards in the form of wireless transponder chips or remote controls.

Another preferred embodiment of the invention distinguishes itself in that the input is logged in a tamper-proof memory of the vehicle device, by means of which the data input to the OBU can be reviewed at any time and this can also be compared, for example, with the current initialization data of the OBU.

The radio interface used for the transmission and back-transmission of data between the OBU and central system is preferably a mobile radio network, which allows complete location independence for the initialization. This embodiment of the method is suitable, in particular, for OBUs of a GNSS toll system (global navigation satellite system-toll charging), which transmit their position report to the central system via a mobile radio network.

Alternatively, the mentioned transmission and back-transmission takes place preferably by means of a network of DSRC radio beacons connected to the central system. This method variant is suitable especially for DSRC toll systems with existing street-side infrastructure and also an initialization of conventional DSRC-OBUs “on the trip.”

According to another preferred embodiment of the invention it is proposed that, when transmitting the driver data and vehicle data from the central system back to the vehicle device, the associated use identifier is also transmitted back, stored in the vehicle device, and compared there with the input use identifier. This allows even better recognition of possible tampering on the OBU.

Preferably, additional identifiers, especially preferably a toll operator identifier, may also be allocated to the use identifier and transmitted back from the central system to the vehicle device. The use identifier thus identifies not only a certain driver and a certain vehicle, but instead, e.g., also a certain toll operator, a certain billing account, etc.

The registering of the driver and vehicle data in the central system can be performed either via a point-of-sale terminal of the central system, e.g., by corresponding personnel, or also by the user himself by means of a Web interface connected to the central system.

### BRIEF DESCRIPTION OF THE DRAWING

The invention will be explained in detail with reference to an embodiment shown in the accompanying drawings. The sole FIG. 1 illustrates the method of the invention with reference to the signal flow between the different components of a road toll system shown as a block-circuit diagram.

FIG. 1 shows a DSRC road toll system with a plurality of vehicle devices or OBUs 1 (only one shown as a representative) that are equipped with a short-range or DSRC transponder 2, in order to communicate with DSRC radio beacons 4 distributed on streets. The vehicle devices 1 are each provided with a unique vehicle device identifier OID.

The radio beacons 4 are connected to a central system 5 which includes at least a server 6 and a data center 7. The server 6 and data center 7 also may be distributed geographically and may communicate with each other via an interface 8, e.g., the Internet. Data may be input to the data center 7 by means of point-of-sale (POS) terminals 9, 10, an Internet terminal 11, and/or a Web interface 12.

The goal of the method described below is to initialize a “blank” OBU 1 in its delivery state with use-specific data or to reinitialize this device for necessary changes to this data, i.e., to write the data to the corresponding register of the OBU 1 or to change the data in this register. The use-specific data comprises, in particular, vehicle data 14 that designate the vehicle in which the OBU 1 is being used, e.g., the official vehicle identifier, the vehicle identification number, the name of the owner, the vehicle type, etc.; and vehicle data 13 that designate the current driver of the vehicle, e.g., the name of the driver, address, accounting data, account or credit card numbers, etc. The driver data 13 and vehicle data 14 together designate a specific use of the OBU 1.

In a first step, the driver data 13 is registered under a unique driver identifier AID and the vehicle data 14 is registered under a unique vehicle identifier VID in the data center 7, and indeed through input via the POS terminals 9, 11 into a driver database 15 and a vehicle database 16 of the data center 7.

The driver identifier AID can be, for example, a unique client identifier, social-security number, license number, identification number, number of a billing account, etc. of the driver. Accordingly, the term “driver identifier” as used herein comprises not only identifiers related directly to the personal identity of the driver, such as his client identifier, social-security number, license number, identification number, etc., but also any identifiers related to his role identities in a certain application, such as one or more identifiers of billing accounts assigned to him, e.g., highway toll accounts, parking garage billing accounts, access-control accounts for reserved areas, etc.

The vehicle identifier VID can be, e.g., the official identifier, the vehicle identification number, a key code, the number of an electronic registration label, etc. of the vehicle.

For registering the driver data and vehicle data 13, 14 in the driver and vehicle database 15, 16, operating personnel at the POS terminals 9, 10 may demand someone to present, and for example, provide appropriate official identification. The registration, however, needs to take place only once; then the driver data and vehicle data 13, 14 can be recalled across the system in the databanks 15, 16 of the data center 7 under the driver and vehicle identifiers AID, VID.

The registering of the driver data and vehicle data 13, 14 can be performed alternatively by the user himself, for example, by means of the Web interface 12. It is also not necessary to register the driver data 13 and vehicle data 14 simultaneously at the central system 5; this may also be performed at a time interval. The detection of the vehicle data 14 under the vehicle identifier VID can also be performed, e.g., in the course of the vehicle registration.

Finally, it is also possible that the driver data 13 and vehicle data 14 are stored on corresponding memory cards, e.g., SIM cards or electronic identification cards, in a machine-readable form and are read into the central system 5 via corresponding reading devices.

In a second step, a use identifier UID is allocated to the combination of a certain driver identifier AID and a certain vehicle identifier VID, i.e., the driver identifier AID and the vehicle identifier VID are linked with each other by means of the use identifier UID. The link can be provided across the system, if desired, in a separate use database 17 of the data center 7.

The use identifier UID can be calculated or allocated, for example, by the data center 7, e.g., the server 6, and then output to the user via the POS terminals 9-11. Alternatively, the user may set the use identifier UID himself, e.g., as a self-selected code, and may be fed into the central system 5 for the registration of the driver data and vehicle data 13, 14, or also later in a separate step (arrow 18), with reference to the driver identifiers and vehicle identifiers AID, VID.

The use identifier UID can correspond in the simplest case directly to the driver identifier AID or to the vehicle identifier VID. Preferably, it is a new code linking these identifiers and can be either selected arbitrarily or formed from the driver identifier AID and the vehicle identifier VID. In the simplest case, the use identifier UID is produced, e.g., as a combination of AID and VID.

After registering the driver data and vehicle data 13, 14 and allocating the identifiers AID, VID or UID in the databases 15-17, all of the data is available for the use-specific initialization of an OBU 1 “on the trip.”

For this purpose, the user of an OBU 1 inputs the use identifier UID—or a combination of the driver identifier and vehicle identifier AID, VID—to the OBU 1 via an interface 19. This can take place manually, e.g., by means of a keypad, or with the help of one or more memory card(s) that are connected to the OBU 1 via the interface 19. If, e.g., instead of the use identifier UID the driver identifier AID and the vehicle identifier VID are input separately, the latter may also be present on separate memory cards, and indeed a first memory card for the driver identifier AID, e.g., a machine-readable credit card or a machine-readable driver's license, and a second memory card for the vehicle identifier VID, e.g., a machine-readable registration label or a vehicle-specific transponder chip, for example, a transponder key.

The input keypad or the memory card(s) may also communicate wirelessly with the OBU 1 for which purpose the interface 19 is, e.g., an infrared, Bluetooth, or RFID interface. In this way, a car radio or cellular telephone constructed with a Bluetooth interface may be used for the input of the driver identifier AID and an RFID transponder starter key of the vehicle may be used for the input of the vehicle identifier VID.

After the input of the use identifier UID or optionally the driver identifier and vehicle identifier AID, VID, the OBU 1 transmits this identifier (these identifiers) together with their separate vehicle device identifier OID to the server 6 of the central system 5 via the radio interface 3 (arrow 19). If the use identifier UID is formed from the driver identifier AID and the vehicle identifier VID and the driver identifier and the vehicle identifier AID, VID are input separately into the OBU 1, the OBU 1 may also form the use identifier UID itself, e.g., from the combination of AID and VID and transmit it together with the device identifier OID to the central system 5. If desired, the registration, allocation, and input of the named identifiers UID, AID, VID may be secured by means of additional PIN codes requiring input.

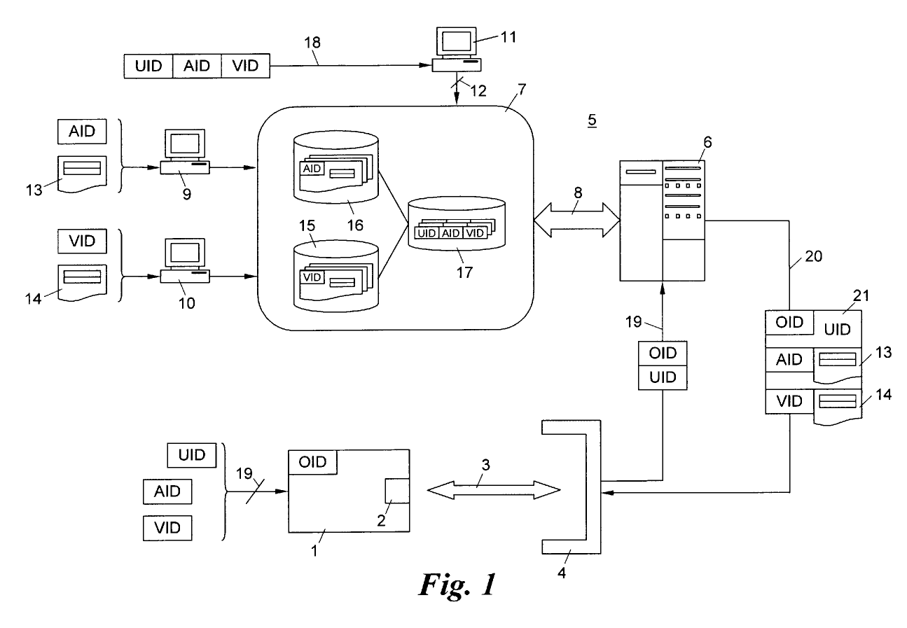

In the central system 5, the driver data and vehicle data 13, 14 registered under the driver identifier AID and vehicle identifier VID can be selected from the driver and vehicle databases 15, 16, if necessary, under the use of the allocation database 17, in order to determine from a received use identifier UID the allocated driver and vehicle identifiers AID, VID. Then, the driver data and vehicle data 13, 14 determined in this way is transmitted back from the central system 5 to the OBU 1 identified by the device identifier OID via the radio interface 3, with reference being made to arrow 20 and data packet 21 of FIG. 1.

The data packet 21 transmitted back can optionally contain again the use identifier UID and/or the driver identifiers and vehicle identifiers AID, VID, in order to crosscheck these optionally in the OBU 1 with the identifiers UID or AID, VID input there. When the data packet 21 is stored in the OBU 1 in a tamper-proof memory, such validation tests can also be performed at any later point in time in continuous operation. In addition, all of the inputs to the OBU 1, e.g., of use identifiers UID and/or driver identifiers and vehicle identifiers AID, VID, can be logged in a tamper-proof memory of the OBU 1, in order to be able to recognize possible tampering. Such tests can also be repeated periodically in the OBU 1, in order to determine differences between the data packet 21 received from the central system 5 and the input data UID, AID, VID and, if necessary, to transmit a tampering alarm to the central system 5.

In addition to the mentioned driver and vehicle identifiers AID, VID, additional identifiers in the data center 7, in particular, in the combinational database 17, may also be allocated to a use identifier UID and transmitted back to the OBU 1 in the data packet 21, for example, a toll operator identifier, a billing account identifier, etc.

The radio interface 3 can be not only of the type presented here of a DSRC radio beacon network, but instead, for example, also the radio interface of a conventional mobile radio network by means of which correspondingly constructed OBUs 1 communicate with the central system 5, as is the case, e.g., in a GNSS toll system.

The invention is not limited to the shown embodiments, but instead comprises all variants and modifications that fall within the scope of the associated claims.

What is claimed is:

1. A method for use-specific initialization of vehicle devices for a road toll system, wherein the devices communicate with a central system via a radio interface and include device identifiers, comprising the steps of:
registering driver data under a driver identifier and vehicle data under a vehicle identifier in the central system;
allocating a use identifier to a driver identifier and to a vehicle identifier in the central system;
inputting the use identifier to a vehicle device;
transmitting the use identifier and the device identifier from the vehicle device to the central system via the radio interface;
determining the driver data and vehicle data for each driver identifier and vehicle identifier to which the received use identifier is allocated in the central system;
transmitting the determined driver data and vehicle data from the central system back to the vehicle device specified by the received device identifier via the radio interface; and
initializing the vehicle device with the received driver data and vehicle data.

2. The method according to claim 1, wherein the allocating step is performed through the inputting of the use identifier by the user.

3. The method according to claim 1, wherein the allocating step is performed through the assignment of the use identifier by the central system and the outputting of the use identifier to the user.

4. The method according to claim 1, wherein the use identifier is formed from the driver identifier and the vehicle identifier.

5. The method according to claim 4, wherein the inputting step takes place by connecting a first memory card with the driver identifier and a second memory card with the vehicle identifier to the vehicle device.

6. The method according to claim 1, wherein the inputting step takes place by connecting at least one memory card with the use identifier stored on the card to the vehicle device.

7. The method according to claim 1, wherein data input by the user takes place by means of an input device of the vehicle device.

8. The method according to claim 5, wherein the memory cards are connected wirelessly to the vehicle device, by means of an infrared, Bluetooth, or RFID interface.

9. The method according to claim 6, wherein the memory cards are connected wirelessly to the vehicle device, by means of an infrared, Bluetooth, or RFID interface.

10. The method according to claim 7, wherein the input device is connected wirelessly to the vehicle device by means of an infrared, Bluetooth, or RFID interface.

11. The method according to claim 1, wherein the data transmitted to the vehicle device is logged in a tamper-proof memory of the vehicle device.

12. The method according to claim 1, wherein the transmitting steps are performed via a mobile radio network.

13. The method according to claim 1, wherein the transmitting steps are performed via a network of DSRC radio beacons connected to the central system.

14. The method according to claim 1, wherein in the step of transmitting back to the vehicle device the driver data and vehicle data, the associated use identifier is also transmitted back, stored in the vehicle device, and compared with the input use identifier.

15. The method according to claim 1, wherein additional identifiers are allocated to the use identifier and transmitted back from the central system to the vehicle device.

16. The method according to claim 15, wherein the additional identifiers include a toll operator identifier.

17. The method according to claim 1, wherein the registering step is performed by means of a point-of-sale terminal.

18. The method according to claim 1, wherein the registering step is performed by means of a Web interface.
